(19) United States
(12) Patent Application Publication
(10) Pub. No.: US 2012/0072993 A1
(43) Pub. Date: Mar. 22, 2012

(54) APPARATUS AND METHOD FOR MUTATING SENSITIVE DATA

(75) Inventor: ANAND SINHA, Bangalore (IN)

(73) Assignee: BUSINESS OBJECTS SOFTWARE LTD., Dublin (IE)

(21) Appl. No.: 12/914,203

(22) Filed: Oct. 28, 2010

(30) Foreign Application Priority Data
Sep. 22, 2010 (IN) 2763/CHE/2010

(51) Int. Cl. G06F 21/24

(52) U.S. Cl. 726/26

(57) ABSTRACT

A computer readable storage medium includes executable instructions to receive data from a data source. Data mutation criteria is applied to designated data elements to produce mutated data that preserves an identifiable relationship between an original designated data element and a corresponding mutated data element. The data mutation criteria also produces mutated data with an identifiable relationship between related mutated data elements. The mutated data is loaded into a report and the report is displayed.

### RELATED APPLICATION DATA

This application claims priority to Indian Patent Application Serial No. 2763/CHE/2010 filed Sep. 22, 2010 entitled APPARATUS AND METHOD FOR MUTATING SENSITIVE DATA, which is incorporated herein by reference.

### FIELD OF THE INVENTION

This invention relates generally to data storage and retrieval. More particularly, this invention relates to mutating retrieved data to protect sensitive information, while preserving identifiable relationships associated with the original data.

### BACKGROUND OF THE INVENTION

There are a number of commercially available products to produce reports from stored data. As used herein, the term report refers to information automatically retrieved (i.e., in response to computer executable instructions) from a data source (e.g., a database, a data warehouse, a plurality of reports, and the like), where the information is structured in accordance with a report schema that specifies the form in which the information should be presented. A non-report is an electronic document that is constructed without the automatic retrieval of information from a data source. Examples of non-report electronic documents include typical business application documents, such as a word processor document, a presentation document, and the like.

A report document specifies how to access data and format it. A report document where the content does not include external data, either saved within the report or accessed live, is a template document for a report rather than a report document. Unlike other non-report documents that may optionally import external data within a document, a report document by design is primarily a medium for accessing and formatting, transforming or presenting external data.

A report is specifically designed to facilitate working with external data sources. In addition to information regarding external data source connection drivers, the report may specify advanced filtering of data, information for combining data from different external data sources, information for updating join structures and relationships in report data, and logic to support a more complex internal data model (that may include additional constraints, relationships, and metadata).

In contrast to a spreadsheet, a report is generally not limited to a table structure but can support a range of structures, such as sections, cross-tables, synchronized tables, sub-reports, hybrid charts, and the like. A report is designed primarily to support imported external data, whereas a spreadsheet equally facilitates manually entered data and imported data. In both cases, a spreadsheet applies a spatial logic that is based on the table cell layout within the spreadsheet in order to interpret data and perform calculations on the data. In contrast, a report is not limited to logic that is based on the display of the data, but rather can interpret the data and perform calculations based on the original (or a redefined) data structure and meaning of the imported data. The report may also interpret the data and perform calculations based on pre-existing relationships between elements of imported data. Spreadsheets generally work within a looping calculation model, whereas a report may support a range of calculation models. Although there may be an overlap in the function of a spreadsheet document and a report document, these documents express different assumptions concerning the existence of an external data source and different logical approaches to interpreting and manipulating imported data.

Report requests commonly include requests for sensitive or confidential information. A request for a report may be denied if the requester does not have the appropriate authorization. Alternately, a report may be delivered with sensitive or confidential information redacted. It would be desirable to provide a technique where a report could be delivered to a requester with sensitive or confidential information mutated to prevent the disclosure of such information, but with sufficient residual information to allow a general understanding and analysis of mutated information.

### SUMMARY OF THE INVENTION

A computer readable storage medium includes executable instructions to receive data from a data source. Data mutation criteria is applied to designated data elements to produce mutated data that preserves an identifiable relationship between an original designated data element and a corresponding mutated data element. The data mutation criteria also produces mutated data with an identifiable relationship between related mutated data elements. The mutated data is loaded into a report and the report is displayed.

### BRIEF DESCRIPTION OF THE FIGURES

The invention is more fully appreciated in connection with the following detailed description taken in conjunction with the accompanying drawings, in which:

FIG. 1 illustrates a computer configured in accordance with an embodiment of the invention.

FIG. 2 illustrates processing operations associated with an embodiment of the invention.

### DETAILED DESCRIPTION OF THE INVENTION

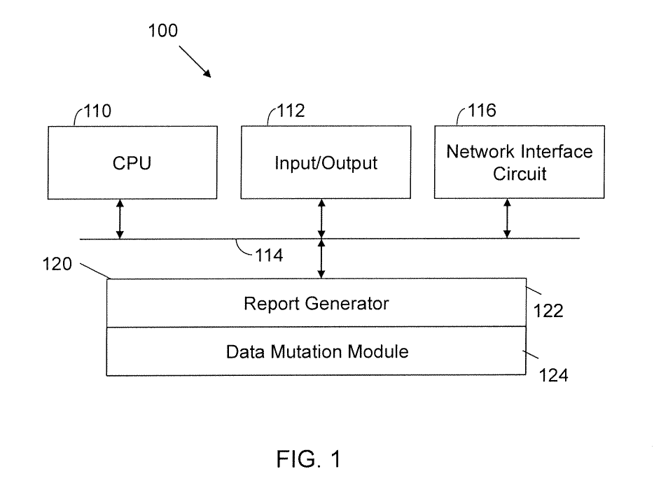

FIG. 1 illustrates a computer 100 configured in accordance with an embodiment of the invention. The computer 100 includes standard components, such as a central processing unit 110 coupled to input/output devices 112 via a bus 114. The input/output devices 112 may include a keyboard, mouse, display, printer and the like. Also connected to the bus 114 is a network interface circuit 116, which allows the computer 100 to operate in a networked environment.

A memory 120 is also connected to the bus 114. The memory includes instructions that are executable by the CPU 110 to implement operations of the invention. In particular, the memory 120 includes a report generator 122 to produce reports using standard techniques. In addition, the memory 120 includes a data mutation module 124. The data mutation module 124 includes executable instructions to mutate sensitive or confidential information within a requested report. As a result, a report requester may receive a report with mutated data that provides sufficient residual information to allow a general understanding and analysis of mutated information, while preserving sensitive or confidential information. The data mutation module 124 may form a part of the report generator 122. Alternately, the data mutation module 124 may be a standalone module called by the report generator 122, as shown in FIG. 1.

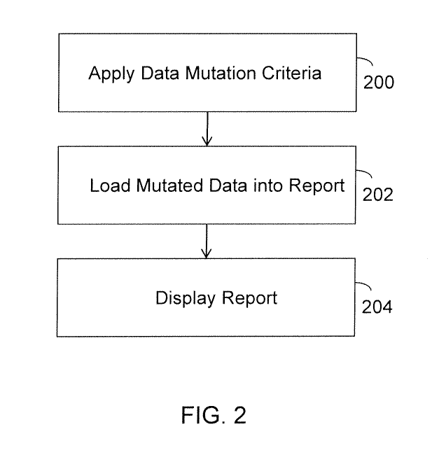

FIG. 2 illustrates processing operations associated with the data mutation module 124. Initially, data mutation criteria is applied 200 to retrieved data. For example, the report generator 122 may retrieve data from a data source to populate a report. The author of the report may specify that certain fields in the report contain sensitive information. Alternately, the data mutation module 124 may apply its own criteria to identify fields with sensitive information. For example, the data mutation module 124 may include rules to identify social security numbers, salary information, medical information, and the like. Once identified, the sensitive information is mutated. In particular, the data is mutated in such a manner as to preserve an identifiable relationship between an original designated data element and a corresponding mutated data element. For example, the identifiable relationship may be a common sequential pattern, such as an internet protocol address pattern, a telephone number pattern, a street address pattern, an email address pattern, a social security number pattern, a currency pattern or a common name pattern. This common sequential pattern reinforces the general nature of the original information.

The mutation criteria may also be configured to produce data with an identifiable relationship between related mutated data elements. For example, original data elements that are equivalent are transformed into identical mutated values. This allows one to review data and identify a basic relationship (e.g., equivalency), even though the precise value is not known.

Other mutation criteria may be used to preserve identifiable relationships between mutated values. For example, sequential values may be presented as mutated values with an incremental difference. That is, the first number in a sequence of values may be transformed to a random number and then the following numbers in the sequence may be incremented by a constant value. In this way, even though the precise values are not known, the relationship between values is preserved.

Another form of mutation criteria to preserve identifiable relationships between mutated values is to multiply all original designated data elements by a common value to maintain relative numeric value relationships between mutated values. This preserves relative relationships between mutated values while masking original values. Alternately, values between a minimum and maximum of the original data may be randomized. The minimum and maximum values may be increased or decreased prior to randomizing.

The data mutation module 124 may mutate values dynamically. That is, the mutated values may be generated on a dynamic basis. This will generally be the case in the event of numeric values. It is useful to analyze the original numeric data elements and produce mutated values to preserve identifiable relationships.

In the event of text values, it is helpful to select mutated values from a preexisting list or lists. Preexisting lists may have an ontological ordering, linguistic ordering and/or be organized as values that satisfy a set of regular expressions. Various criteria may be used to select or derive a mutated value from one or more of such lists. The data itself may be analyzed and then matched to an appropriate list. Alternately or in addition, metadata associated with the data (e.g., column name, column restrictions, report name) may be analyzed to select an appropriate list. For example, a database column may be entitled “profit”, in which case a profit ontology may be invoked to identify appropriate mutated values. The metadata may provide a hint about the type of data. For example, a column name of “Author” may lead to a guess that the data pertains to people. Data may be analyzed to determine whether this guess is appropriate. The analysis may be based upon a check to determine if the data is alphabetic, includes hyphens, accented characters, etc. If the designated criteria is met, then the new replacement values are generated from a list that contains values of the designated type.

If a database column specifies “telephone number”, then a telephone number sequential pattern is invoked. Random numbers may then be placed in the telephone number sequential pattern. If a replacement format is not available, the field name and/or type may be used to derive a replacement format. This may be done based upon the original value or the initial N values of the original value.

Various techniques may be used to insure that the same replacement value is used for duplicate original values. For example, each unique old value may be used as a key into a hash table. The values in the hash table are the computed replacement values. Therefore, when a repeated value is encountered, the same replacement value from the hash table is fetched. This may be implemented with the following sequence of instructions.

While (o: old-val_list)
{

Object replacement = has_store.get(o);
If (replacement == null)

replacement = getNextNewValue (VAL_FORMAT)

replacement_val_list.add(replacement)

}

An ontological ordered list expresses a set of types, properties and relationships in a domain. Domains are selected based upon the types of reports produced by the report generator. For example, if a report generates a report with employee information, then an ontological ordered list for this domain is constructed. The list may include fields for address, telephone number, and social security number. Lists of mutated values for such fields may then be used. For example, in the event of an address field, a template along the following lines may be used: #### ************. In this case, each # value is replaced with a number and each * value is replaced with a character to form a street name or a street-like name. Similarly, a telephone number pattern may be defined as (###)###-####, while a social security number pattern may be defined as ###-##-####. The ontological ordered list is used to match an original data element to an entry in the list. A mutated value is associated with the entry and is substituted for the original data element. The following table lists alternate patterns that may be used in accordance with embodiments of the invention.

| | |
|---|---|
| Person_%AUTO_INCR_NUM% | Example: Person_1, |
| | Person_2, Person_3 . . . |
| Name_%ALPHA% | Example: Name_A, |
| | Name_B, Name_C, . . . |
| %val%*%RAND(50, 100)% | The actual numeric |
| | value should be |
| | multiplied by |
| | random integer |
| | between 50 and 100 |
| %NUM3%.%NUM3%.%NUM3%.%NUM3% | Example: 123.456.789 |
| | can be used for data that |
| | looks like an IP address |

A linguistic ordered list expresses information about the structure and meaning of language associated with a report. This information may be used to select mutated values with similar structure and meaning. For example, if values such as “author” or “manager” are identified, then a linguistic analysis draws a conclusion that a person is involved. Accordingly, a list of individual mutated names may be invoked.

Regular expressions may also be used to form mutated values. Regular expressions specify matching characters, words or patterns of characters. A list of regular expressions may be used to identify language components and suitable substitutes for such language components that are used to produce mutated values. Each list of regular expressions represents some sequence of digits, alphabetic terms and special characters. Run lengths for each of these items could be maintained to help organize lists. These expressions are relatively rare. Therefore, instead of creating pre-existing lists of regular expressions, logic can be used to dynamically derive regular expressions to be used for mutation. The regular expression for a text value may vary from a very generic one (such as, (?)*) to a very specific one (equal to the data itself). For example, the text value “I050476” can be represented by many regular expressions like: (?)*, ???????, ?(#)*, ?######, I(#)*, I######, . . . , I05047?, I05047#, 1050476, and so on. In this example, ‘?’ represents any character, ‘#’ represents a numeric character and ‘*’ represents any number of repetitions of the character preceding it. A set of regular expressions may be generated for the each text value in the list, and the least constrained regular expression matching all the values may be selected as the regular expression for mutating the values. For example, if the data were {1050476, 1050111, 1050222, 1050444, . . . } then the regular expression selected could be I050###. It should be noted that (?)*, ???????, ?(#)*, ?######, I(#)*, I######, I0#####, and so on, would all be candidates for choice of regular expression, but I050### was selected by virtue of being most restrictive among the candidates. The selected regular expression may be further mutated. Such logic may include criteria, such as incrementing the ASCII numeric value for such an item and then rotating the placement of each item in the sequence of terms.

In order to reduce the amount of data used for analysis, the data analysis may include a data reduction phase. Various techniques may be used to secure a subset of data representative of an entire data set. For example, the following approach may be used:

int[ ]get_fibonnaci_indices (int max)
{

Return {1, 2, 3, 5, 8, 13, 21, 34, 55, ..., N};

//here the sum of last 2 integers exceeds max;

fib_index_list = get_fibonnaci_indices(max);
while (i: fib_index_list)
{

Sample_Data.add(data[i]);
Sample_Data.add(data[max−i]);

}
fib_index_list = fibonnaci_indices (max/2);
while(i: fib_index_list)
{

Sample_Data.add(data[max/2 + i]);
Sample_Data.add(data[max/2 − i]);

}

This logic of data reduction is effective because it uses clustered data at the beginning, end and middle. This diverse data is a small subset of the original data.

Returning to FIG. 2, after data mutation, mutated data is loaded into a report 202. Fields of mutated data may be demarked in the report. For example, the mutated values may be demarked by an asterisk, italics or in some other manner. The report is then displayed 204. The report may be displayed on a monitor of the input/output devices 112.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising executable instructions to:
receive data from a data source;
apply data mutation criteria to designated data elements to produce mutated data that preserves an identifiable relationship between an original designated data element and a corresponding mutated data element;
load the mutated data into a report; and
display the report.

2. The computer readable storage medium of claim 1 wherein the identifiable relationship is a common sequential pattern.

3. The computer readable storage medium of claim 2 wherein the common sequential pattern is selected from an internet protocol address pattern, a telephone number pattern, a street address pattern, an email address pattern, a social security number pattern, a currency pattern and a common name pattern.

4. The computer readable storage medium of claim 1 further comprising executable instructions to apply mutation criteria to designated data elements to produce mutated data with an identifiable relationship between related mutated data elements.

5. The computer readable storage medium of claim 4 wherein the identifiable relationship is identical mutated values for identical original designated data elements.

6. The computer readable storage medium of claim 4 wherein the identifiable relationship is an incremental numerical value.

7. The computer readable storage medium of claim 4 wherein the identifiable relationship is established by multiplying original designated data elements by a common value to maintain relative numeric value relationships between mutated values.

8. The computer readable storage medium of claim 1 further comprising executable instructions to demark mutated data in the report.

9. The computer readable storage medium of claim 1 wherein the mutated data is dynamically generated.

10. The computer readable storage medium of claim 1 wherein the mutated data is selected from a list of mutated values.

11. The computer readable storage medium of claim 10 wherein the list of mutated values has an ontological ordering.

12. The computer readable storage medium of claim 10 wherein the list of mutated values has a linguistic ordering.

13. The computer readable storage medium of claim 10 wherein the list of mutated values is organized as a set of regular expressions.

14. The computer readable storage medium of claim 10 wherein the data mutation criteria includes executable instructions to analyze metadata associated with an original designated data element.

15. The computer readable storage medium of claim 1 further comprising executable instructions to derive from the data a representative subset of data.
